(19) United States
(12) Patent Application Publication
(10) Pub. No.: US 2024/0084616 A1
(43) Pub. Date: Mar. 14, 2024

(54) FOLDING VEHICLE ROOFTOP TENT

(71) Applicant: Jinlong WANG, Beijing (CN)

(72) Inventor: Jinlong WANG, Beijing (CN)

(73) Assignee: Beijing Unistrengh International Trade Co., Ltd., Beijing (CN)

(21) Appl. No.: 17/943,395

(22) Filed: Sep. 13, 2022

(51) Int. Cl. E04H 15/06; E04H 15/56; E04H 15/64; E06C 5/04

(52) U.S. Cl. CPC E04H 15/06; E04H 15/56; E04H 15/64; E06C 5/04; E04H 15/40

(57) ABSTRACT

The present disclosure provides a folding vehicle rooftop tent, including a folding bottom plate, where two folding supporting rods are detachably and fixedly connected below the folding bottom plate and is used to stably support the folding bottom plate above the vehicle roof, and a tent main body is detachably and fixedly mounted above the folding bottom plate. The folding vehicle rooftop tent provided by the present disclosure is convenient to disassemble and assemble, stable to use, small in occupied area after folding, and more convenient to store and carry.

### FIELD OF TECHNOLOGY

The present disclosure relates to the field of a tent, and in particular to a folding vehicle rooftop tent.

### BACKGROUND

For people who like to go camping by car, a folding vehicle rooftop tent is very convenient. However, an existing folding vehicle rooftop tent is wider after being folded, is not beneficial to carry and takes up a large space after being stored. For some cars with small space, the tent cannot be stored in the car. If a small folding vehicle rooftop tent is selected, the space during use is limited.

### SUMMARY

An objective of the present disclosure is to provide a folding vehicle rooftop tent, which has a large use space, is wider after being folded, convenient to carry and store, suitable for vehicles with large capacity space, and also suitable for vehicles with small capacity space.

To achieve the above objective, the present disclosure provides the following technical solution:

a folding vehicle rooftop tent includes a folding bottom plate and a tent main body, where the tent main body is detachably and fixedly connected to the folding bottom plate; the folding bottom plate includes a middle bottom plate group formed by hinging two side plates and several middle bottom plates, and the two side bottom plates are respectively hinged with two sides of the middle bottom plate group; and two hinge grooves are formed in one side surface of each of the side bottom plates, hinges are mounted in the hinge grooves, and from the side bottom plate on one side to the side bottom plate on the other side in the folding bottom plate, the hinges between every two adjacent bottom plates are mounted sequentially and alternately in forward and reverse directions.

Further, two folding supporting rods are detachably and fixedly connected below the folding bottom plate, the folding supporting rods include several supporting rods, and a lockable hinge is fixedly mounted between every two adjacent supporting rods.

Further, connecting ends of the supporting rods arc respectively and fixedly connected to a first rotating hinge and a second rotating hinge, one half part of a hinged end of the first rotating hinge is provided with a first inserting seam allowance, and the other half part of the hinged end of the first rotating hinge is provided with a stepped first rotating hinged part extending downwards; one half part of a hinged end of the second rotating hinge is provided with a stepped second rotating hinged part extending downwards, and the other half part of the hinged end of the second rotating hinge is provided with a second inserting seam allowance; the first rotating hinged part is inserted into the second inserting seam allowance; the first rotating hinge and the second rotating hinge are hinged through a hinge rotating shaft; a size of the first inserting seam allowance is greater than the area swept by an end part of the second rotating hinged part rotating around the hinge rotating shaft by 180°; and a size of the second inserting seam allowance is greater than the area swept by an end part of the first rotating hinged part rotating around the hinge rotating shaft by 180′.

Further, an upper surface of the first rotating hinged part is provided with a jackscrew hole, a jackscrew concave platform is arranged on a bottom edge of the second inserting seam allowance, a locking rotary knob is spirally connected into the jackscrew hole, and an end part of the locking rotary knob abuts against the jackscrew concave platform during use.

Further, a first tent mounting hole penetrating through an upper surface and a lower surface is formed at a side corner, without the hinge groove, of the side bottom plate, and the first tent mounting hole is used for mounting and fixing the tent main body.

Further, the tent main body includes two supporting skeletons, corner connectors are respectively arranged at two ends of the two supporting skeletons, the four corner connectors are respectively and fixedly connected to corners of the two side bottom plates, and end parts of the supporting skeletons are in inserting connection with the corner connectors.

Further, at least two fixing through holes are formed in an upper surface of each of the corner connectors; a second tent mounting hole is formed at the position, corresponding to the first tent mounting hole in the side bottom plate, of the corner connector; a hollow inserting pipe with a closed bottom is arranged below the second tent mounting hole; the hollow inserting pipe is inserted into the first tent mounting hole; and an end part of each of the supporting skeletons is inserted into the hollow inserting pipe.

Further, the bottom of the tent main body is fixedly connected to several straps; and when the tent main body is mounted on the folding, bottom plate, the straps bypass the edge of the folding bottom plate to be folded at the bottom of the folding bottom plate and to be fixedly connected to the folding supporting rod through a bolt.

Further, the folding vehicle rooftop tent further includes a telescopic ladder, where the telescopic ladder is detachably and fixedly connected to the side of the folding bottom plate.

Further, the telescopic ladder includes two connecting pieces, each of the connecting pieces includes channel steel, a side edge of the lower side of the channel steel is spirally connected to a fixing bolt, an outer surface of a bottom side of the channel steel is fixedly connected to a fixed end of a hinged piece, and a hinged, end of the hinged piece is hinged with a telescopic ladder main body.

Further, the side bottom plates and the middle bottom plates have the same composition structure; each of the side bottom plates includes a bottom plate frame; an upper surface and a lower surface of the bottom plate frame are respectively and fixedly connected to an upper surface plate and a lower surface plate; and shapes and sizes of the upper surface plate and the lower surface plate are respectively matched with those of the bottom plate frame.

According, to the analysis, the folding vehicle rooftop tent disclosed by the present disclosure has a folding bottom plate with a plurality of bottom plates, each bottom plate can be folded sequentially, and the occupied space after folding is relatively small; the folding supporting rods can be folded, and the folded and unfolded states can be adjusted and switched, so the folding supporting rods are firmer to use and have a relatively short length after folding; the tent main body can be built rapidly through corner connectors; and after the tent main body is supported, the tent main body is fixedly connected to the folding bottom plate by straps; and compared with the prior art, the folding vehicle roof top tent provided by the present disclosure is convenient to disassemble and assemble, stable to use, small in occupied area after folding and more convenient to store and carry.

### BRIEF DESCRIPTION OF THE DRAWINGS

The drawings of the specification that constitutes a part of the present application are used to provide a further understanding of the present disclosure. The exemplary embodiments of the present disclosure and the description thereof are used to explain the present disclosure, and do not constitute an improper limitation of the present disclosure. In the drawings:

FIG. 1 is a schematic exploded structural diagram according to an embodiment of the present disclosure;

FIG. 2 is a schematic exploded structural diagram of a folding bottom plate according to an embodiment of the present disclosure;

FIG. 3 is a structural schematic diagram of a side bottom plate according to an embodiment of the present disclosure;

FIG. 4 is a schematic exploded structural diagram of a side bottom plate according to an embodiment of the present disclosure;

FIG. 5 is an enlarged schematic diagram of a region A circled by a dotted line in FIG. 1;

FIG. 6 is a schematic exploded structural diagram of a first rotating hinge, and a second rotating hinge according to an embodiment of the present disclosure;

FIG. 7 is a structural schematic diagram of a second rotating hinge with a jackscrew concave platform side according to an embodiment of the present disclosure;

FIG. 8 is a structural schematic diagram when a first rotating hinge and a second rotating hinge rotate in a locking manner after being connected according to an embodiment of the present disclosure;

FIG. 9 is a structural schematic diagram of a tent main body according to an embodiment of the present disclosure;

FIG. 10 is an enlarged schematic diagram of a region C circled by a dotted line in FIG. 9;

FIG. 11 is a structural schematic diagram of a corner connector according to an embodiment of the present disclosure;

FIG. 12 is an enlarged schematic diagram of a region 13 circled by a dotted line in FIG. 1; and

FIG. 13 is a structural schematic diagram of a bottom after mounting according to an embodiment of the present disclosure.

### DESCRIPTION OF REFERENCE NUMERALS

1—folding bottom plate;
11—side bottom plate; 12—middle bottom plate; 13—hinge;
110—hinge groove; 111—bottom plate frame; 112—upper surface plate; 113—lower surface plate; 114—first tent mounting hole;
2—folding supporting rod;
21—supporting rod; 22—first rotating hinge; 220—first inserting seam allowance; 221—first rotating hinged part; 222—first hinged shaft hole; 223—jackscrew hole; 23—second rotating hinge; 230—second rotating hinged part; 231—second inserting seam allowance; 232—first hinged shaft hole; 233—jackscrew concave platform; 24—hinge rotating shaft; 25—locking rotary knob;
3—tent main body;
31—supporting skeleton; 32—corner connector; 33—strap; 321—fixing through hole: 322—second tent mounting hole: 323—hollow inserting pipe;
4—telescopic ladder;
41—connecting piece; 410—channel steel; 411—fixing bolt; 412—hinged piece.

### DETAILED DESCRIPTION OF THE EMBODIMENTS

The present disclosure is described in detail below with reference to the accompanying drawings and embodiments. Each example is provided to explain the present disclosure instead of limiting the present disclosure. In fact, those skilled in the art will appreciate that modifications and variations may be made in the present disclosure without departing from the scope or spirit of the present disclosure. For example, features shown or described as one part of one embodiment may be applied to another embodiment to generate yet another embodiment. Therefore, it is expected that the present disclosure includes such modifications and variations that fall within the scope of the appended claims and their equivalents.

In the description, of the present disclosure, orientation or position relationships indicated by terms “longitudinal” “transverse”, “upper”, “lower”, “front”, “rear”, “left”, “right”, “vertical”, “horizontal”, “top”, “bottom” and the like are orientation or position relationships shown in the drawings and these terms are merely for facilitating description of the present disclosure, but not for requiring that the present disclosure must be constructed and operated in a specific orientation, and thus, these terms cannot be understood as a limitation to the present disclosure. As used in the present disclosure, the terms “connected”, “connection” and “set” should be understood in a broad sense, for example, they may be fixed connection or detachable connection, they may be direct connection or indirect connection through an intermediate part; or they may be wired connection and wireless connection, or may be connection through a wireless communication signal. For those of ordinary skill in the field, the specific meanings of the terms may be understood according to the specific conditions.

The accompanying drawings show one or more examples of the present disclosure. The detailed description uses reference numerals and letters to refer to the features in the accompanying drawings. Similar numeral references in the drawings and description have been used to refer to the similar parts in the present disclosure. As used herein, the terms “first”, “second” and “third” are used interchangeably to distinguish one component from another component, and are not intended to indicate the position or importance of individual components.

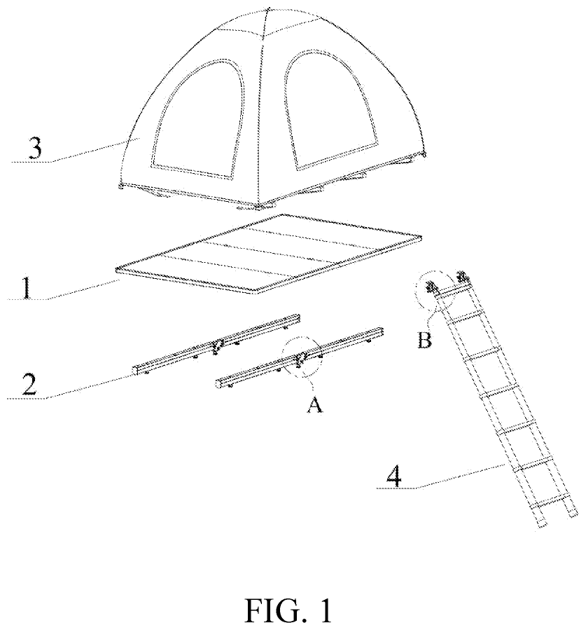

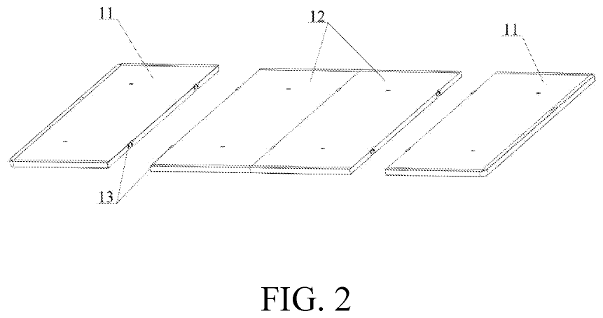

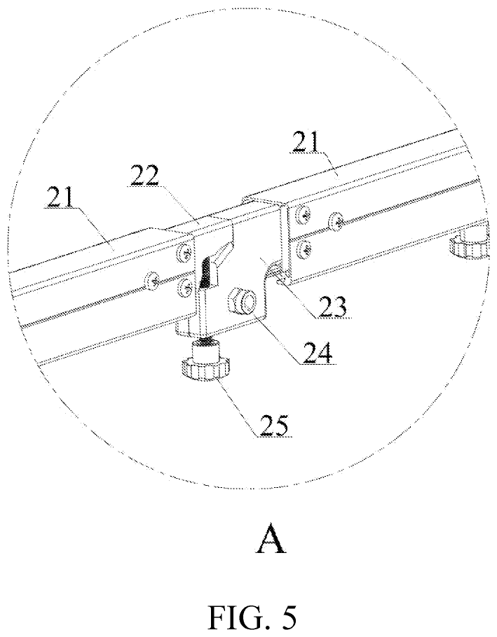

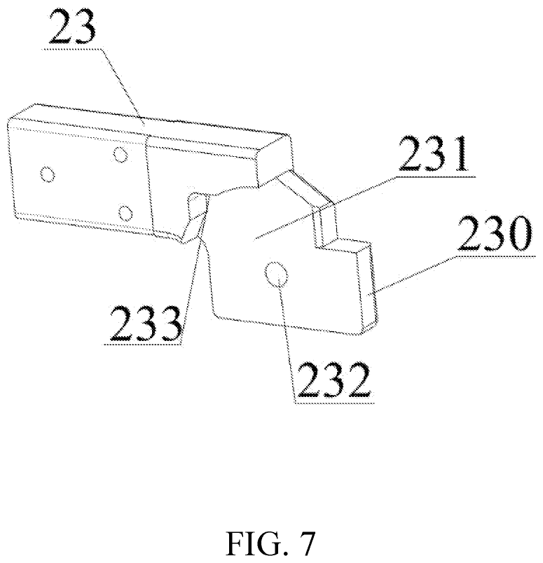

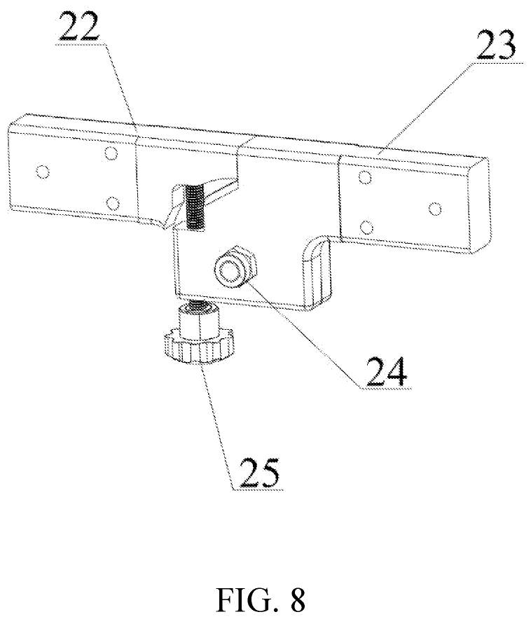

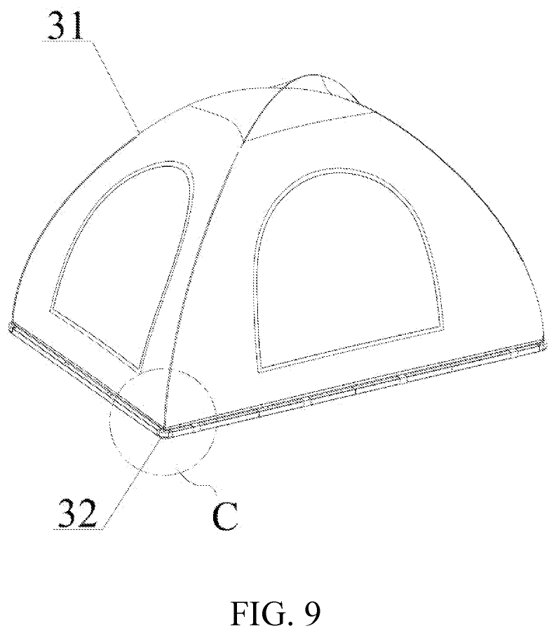

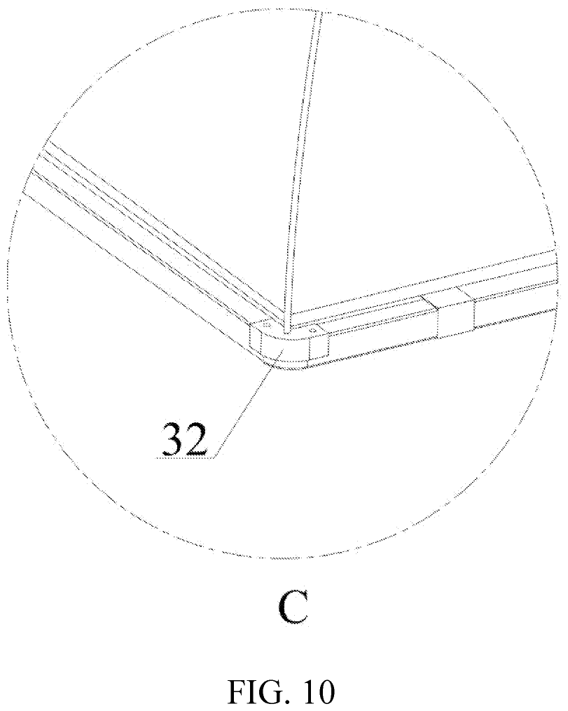

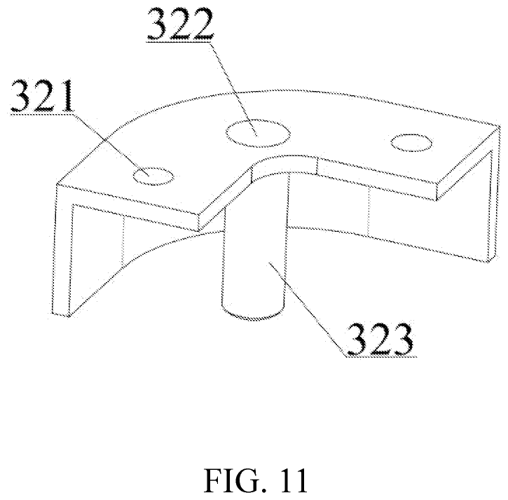

As shown in FIG. 1 to FIG. 13, according to the embodiment of the present disclosure, a folding vehicle rooftop tent is provided. The folding vehicle rooftop tent includes a folding bottom plate 1, where two folding supporting rods 2 are detachably and fixedly connected below the folding bottom plate 1 and is used to stably support the folding bottom plate 1 above the vehicle roof, and a tent main body 3 is detachably and fixedly mounted above the folding bottom plate 1.

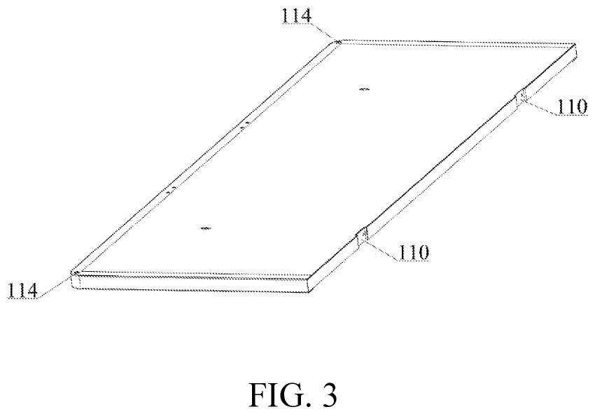

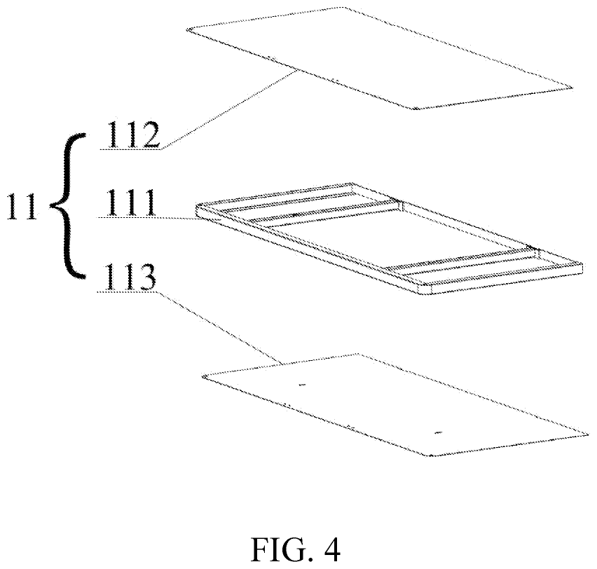

The folding bottom plate 1 includes two side bottom plates 11, and two mutually hinged middle bottom plates 12 are hinged in the middle of the two side bottom plates 11. As shown in FIG. 3, two hinge grooves 110 are formed in one side of each of the side bottom plates 11; correspondingly, two hinge grooves 110 are respectively formed in two sides of each of the middle bottom plates 12; hinges 13 are mounted in the hinge grooves 110; and fixed connection parts of the hinges 13 are inlaid in the hinge grooves 110, so that when two adjacent bottom plates are unfolded, the sides of the two bottom plates cling to each other, and the two adjacent bottom plates are hinged by mounting the hinges 13 in the corresponding hinge groove 110. From the side bottom plate 11 on one side to the side bottom plate 11 on the other side in the folding bottom plate 1, the hinges 13 between every two adjacent bottom plates are, mounted sequentially and alternately in forward and reverse directions, so that the bottom plates are folded sequentially. The side bottom plates 11 and the middle bottom plates 12 have the same composition structure. Taking the side bottom plates 11 as an example, as shown in FIG. 4, each of the side bottom plates 11 includes a bottom plate frame 111, an upper surface and a lower surface of the bottom plate frame 111 are respectively and fixedly connected to an upper surface plate 112 and a lower surface plate 113, and shapes and sizes of the upper surface plate 112 and the lower surface plate 113 are respectively matched with those of the bottom plate frame 111. A first tent mounting hole 114 penetrating through an upper surface and a lower surface is formed at a side corner, without the hinge groove, of the side bottom plate 11, and the first tent mounting hole 114 is used for mounting and fixing the tent main body 3.

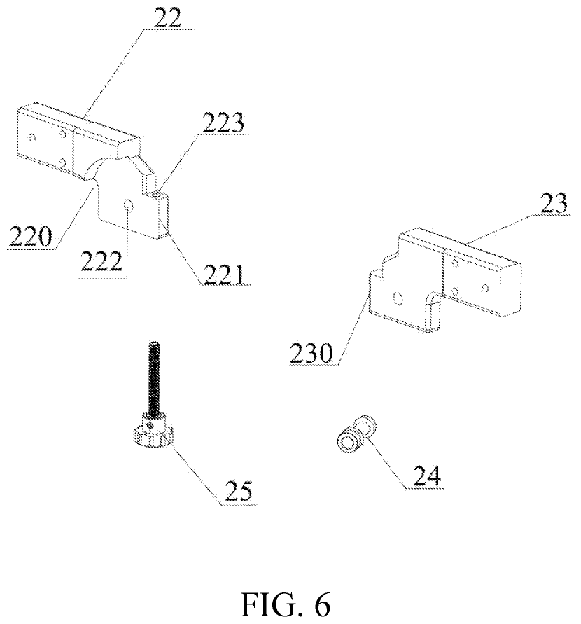

As shown in FIG. 6 to FIG. 8, the folding supporting rod 2 includes two mutually hinged supporting rods 21, connecting ends of the two supporting rods 21 are respectively and fixedly connected to a first rotating hinge 22 and a second rotating hinge 23, and the first rotating hinge 22 and the second rotating hinge 23 are hinged through a hinge rotating shaft 24. One end of the first rotating hinge 22 is in inserting connection and fixed with one end of one supporting rods 21, a fan-shaped first inserting seam allowance 220 is formed on one half part of the other end of the first rotating hinge 22, a stepped first rotating hinged part 221 extending downwards is arranged on the other half part of the other end of the first rotating hinge 22, a first hinged shaft hole 222 is formed in a surface of the first rotating hinged part 221, correspondingly, one end of the second rotating hinge 23 is in inserting connection ad fixed with one end of the other supporting, rod 21, a stepped second rotating hinged part 230 extending downwards is arranged on one half part of the other end of the second rotating hinge 23, a fan-shaped second inserting seam allowance 231 is formed on the other half part of the other end of the second rotating hinge 23, and a second hinged shaft hole 232 is formed in a surface of the second rotating hinged part 230. The area of the first inserting seam allowance 220 is greater than the area swept by an end part of the second rotating hinged part 230 rotating around the hinge rotating shaft 24 by 180°; and the area of the second inserting seam allowance 231 is greater than the area swept by an end part of the first rotating hinged part 221 rotating around the hinge rotating shaft 24 by 180°.

The first rotating hinged part 221 is inserted into the second inserting seam allowance 231; the second rotating hinged part 230 is inserted into the first inserting seam allowance 220; the hinge rotating shaft 24 sequentially passes through the first hinged shaft hole 222 and the second hinged shaft hole 232; the first rotating hinged part 221 can rotate around the hinge rotating shaft 24 in the second inserting seam allowance 231; and the second rotating hinged part 230 can rotate around the hinge rotating shaft 24 in the first inserting seam allowance 220. The step design of the first rotating hinged part 221 and the second rotating hinged part 230 facilitate rotation of the first rotating hinged part 221 and the second rotating hinged part 230 in the inserting seam allowances.

For the convenience to control the unfolded or folded state of the first rotating hinged part 221 and the second rotating hinged part 230, a jackscrew hole 223 is formed in an upper surface of the first rotating hinged part 221; a jackscrew concave platform 233 is arranged on a bottom side of the second inserting seam allowance 231; when the locking rotary knob 25 is spirally connected in the jackscrew hole 223 and abuts against the jackscrew concave platform 233, the first rotating hinged part 221 and the second rotating hinged part 230 are unfolded and cannot be folded; and when the locking rotary knob 25 is spirally connected in the jackscrew hole 223 and does not abut against the jackscrew concave platform 233, the first rotating hinged part 221 and the second rotating hinged part 230 can be folded.

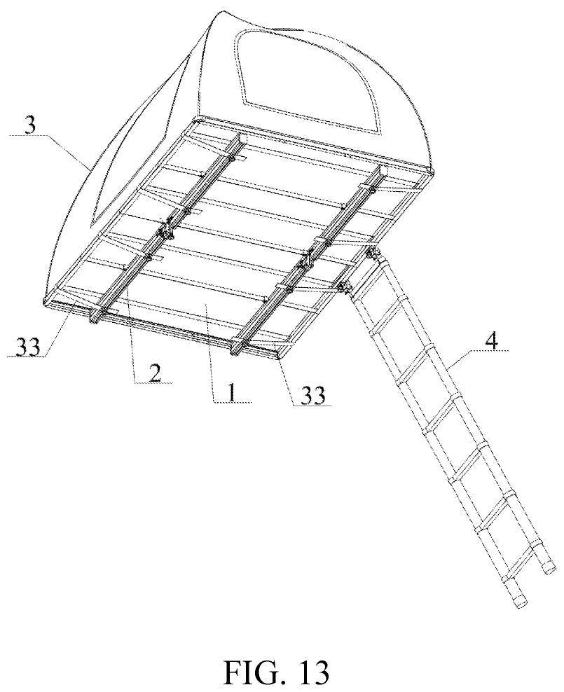

The tent main body 3 includes two crossed supporting skeletons 31 for supporting tent cloth, corner connectors 32 are respectively arranged at two ends of the two supporting skeletons 31, the four corner connectors 32 are respectively and fixedly connected to corners of the two side bottom plates 11, and end parts of the supporting skeletons 31 are in inserting connection with the corner connectors 32. Two fixing through holes 321 are formed in an upper surface of each of the corner connectors 32 and used for fixed connection between the corner connectors 32 and the side bottom plates 11; a second tent mounting hole 322 is formed at a position, corresponding to the first tent mounting hole 114 in the side bottom plate 11, of each of the corner connectors 32; a hollow inserting pipe 323 with a closed bottom is arranged below the second tent mounting hole 322; the hollow inserting pie 323 is inserted in the first tent mounting hole 114; end parts of the supporting skeletons 31 are inserted into the hollow inserting pipe 323; and compared with the single hole-inserting fixation manner, it is more stable to fix the end parts of the supporting skeletons 31 by the hollow inserting pipe 323. As shown in FIG. 13, the bottom of the tent main body 3 is further fixedly connected to several straps 33; and when the tent main body 3 is mounted on the folding bottom plate 1, the straps 33 bypass the edge of the folding bottom plate 1 to be folded at the bottom folding plate 1 and to be fixedly connected to the bottom of the folding supporting rod 2 through a bolt.

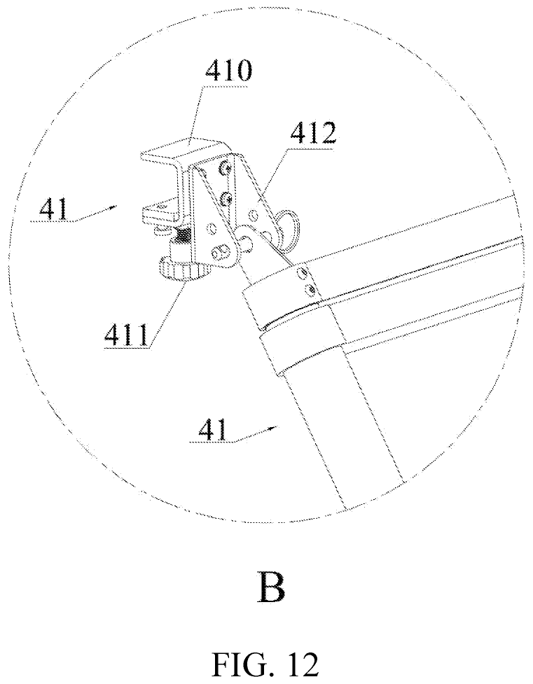

The folding vehicle rooftop tent provided by the present disclosure further includes a telescopic ladder 4, the telescopic ladder 4 is detachably and fixedly connected to the side of the folding bottom plate 1, and the telescopic ladder 4 includes two connecting pieces 41. As shown in FIG. 12, each of the connecting pieces 41 includes channel steel 410 for being fixedly connected to the side of the folding bottom plate 1; a lower side of the channel steel 410 is spirally connected to, a fixing bolt 411: and when a screw-in end of the fixing bolt 411 abuts against the lower surface of the folding bottom plate 1, the connecting piece 41 is fixedly connected to the folding bottom plate 1, an outer surface of the bottom side of the channel steel 410 is fixedly connected to a fixing, end of the hinged piece 412, and a hinged end of the hinged piece 412 is hinged with a telescopic ladder main body 42. The telescopic ladder 4 can be disassembled and assembled rapidly by rotating the fixing bolt 411, and the telescopic ladder main body 42 and the connecting piece 41 are hinged, so that different supporting angles of the telescopic ladder 4 can be realized, thereby facilitating use in different situations.

From the above description, it can be seen that the above embodiments of the present disclosure achieve the following technical effects:

the folding vehicle rooftop tent provided by the present disclosure has a folding bottom plate with a plurality of bottom plates, the bottom plates can be folded sequentially, and the occupied area after folding is relatively small, thereby facilitating storage and carrying.

The folding supporting rod can be folded the folded and unfolded states can be adjusted and switched, reliable use is achieved, and the length after folding is relatively short, thereby facilitating storage and carrying.

The tent main body can be rapidly built through the corner connectors. After the tent main body is supported, the tent main body is fixedly connected to the folding bottom plate by the straps, the building mode is more convenient, and firm fixation is achieved.

Compared with the prior art, the folding vehicle rooftop tent provided by the present disclosure is convenient to disassemble and assemble, stable to use, small in occupied area after folding, and more convenient to store and carry.

The foregoing is merely illustrative of the preferred embodiments of the present disclosure and is not intended to limit the present disclosure, and various changes and modifications may be made by those skilled in the art. Any modifications, equivalent substitutions, improvements, etc. made within the spirit and scope of the present disclosure should be included within the protection scope of the present disclosure.

1. A folding vehicle rooftop tent, comprising: a folding bottom plate and a tent main body, wherein the tent main body is detachably and fixedly connected to the folding bottom plate;
the folding bottom plate comprises a middle bottom plate group formed by hinging two side plates and several middle bottom plates, and the two side bottom plates are respectively hinged with two sides of the middle bottom plate group; and
two hinge grooves are formed in one side surface of each of the side bottom plates, hinges are mounted in the hinge grooves, and from the side bottom plate on one side to the side bottom plate on the other side in the folding bottom plate, the hinges between every two adjacent bottom plates are mounted sequentially and alternately in forward and reverse directions.

2. The folding vehicle rooftop tent according to claim 1,
wherein two folding supporting rods are detachably and fixedly connected below the folding bottom plate, the folding supporting rods comprise several supporting, rods, and, a lockable hinge is fixedly mounted between every two adjacent supporting rods.

3. The folding vehicle rooftop tent according to claim 2,
wherein connecting ends of the supporting rods are respectively and fixedly connected to a first rotating hinge and a second rotating hinge;
one half part of a hinged end of the first rotating hinge is provided with an inserting seam allowance, and the other half part of the hinged end of the first rotating hinge is provided with a stepped first rotating hinged part extending downwards;
one half part of a hinged end of the second rotating hinge is provided with a stepped second rotating hinged part extending downwards, and the other half part of the hinged end of the second rotating hinge is provided with a second inserting seam allowance;
the first rotating hinged part is inserted into the second inserting seam allowance;
the first rotating hinge is hinged with the second rotating, hinge through a hinge rotating shaft;
the area of the first inserting seam allowance is larger than the area swept by an end part of the second rotating hinged part rotating around the hinge rotating shaft by 180°; and
the area of the second inserting seam allowance is larger than the area swept by an end part of the first rotating hinged part rotating around the hinge rotating shaft by 180°.

4. The folding vehicle rooftop tent according to claim 3,
wherein an upper surface of the first rotating hinged part is provided with a jackscrew hole, a jackscrew concave platform is arranged on a bottom edge of the second inserting seam allowance, a locking rotary knob, is spirally connected into the jackscrew hole, and an end part of the locking rotary knob abuts against the jackscrew concave platform during use.

5. The folding vehicle rooftop tent according to claim 2,
wherein a first tent mounting hole penetrating through an upper surface and a lower surface is formed at a side corner, without the hinge groove, of the side bottom plate, and the first tent mounting hole is used for mounting and fixing the tent main body.

6. The folding vehicle rooftop tent according to claim 5,
wherein the tent main body comprises two supporting skeletons, corner connectors are respectively arranged at two ends of the two supporting skeletons, the four corner connectors are respectively and fixedly connected to corners of the two side bottom plates, and end parts of the supporting skeletons are in inserting connection with the corner connectors.

7. The folding vehicle rooftop tent according to claim 6,
wherein at least two fixing through holes are formed in an upper surface of each of the corner connectors; a second tent mounting hole is formed at the position, corresponding to the first tent mounting hole in the side bottom plate, of the corner connector; a hollow inserting pipe with a closed bottom is arranged below the second tent mounting hole; the hollow inserting pipe is inserted into the first tent mounting hole; and an end part of each of the supporting skeletons is inserted into the hollow insetting pipe.

8. The folding vehicle rooftop tent according to claim 2,
wherein the bottom of the tent main body is fixedly connected to several straps; and when the tent main body is mounted on the folding bottom plate, the straps bypass the edge of the folding bottom plate to be folded at the bottom of the folding bottom plate and to be fixedly connected to the folding supporting rod through a bolt.

9. The folding vehicle rooftop tent according to claim 8,
further comprising a telescopic ladder, wherein the telescopic ladder is detachably and fixedly connected to the side of the folding bottom plate.

10. The folding vehicle rooftop tent according to claim 9,
wherein the telescopic ladder comprises two connecting pieces, each of the connecting pieces comprises channel steel, a side edge of the lower side of the channel steel is spirally connected to a fixing bolt, an outer surface of a bottom side of the channel steel is fixedly connected to a fixed end of a hinged piece, and a hinged end of the hinged piece is hinged with a telescopic ladder main body.

11. The folding vehicle rooftop tent according to claim 2,
wherein the side bottom plates and the middle bottom plates have the same composition structure; each of the side bottom plates comprises a bottom plate frame; an upper surface and a lower surface of the bottom plate frame are respectively and fixedly connected to an upper surface plate and a lower surface plate; and shapes and sizes of the upper surface plate and the lower surface plate are respectively matched with those of the bottom plate frame.
